(19) United States
(12) Patent Application Publication
(10) Pub. No.: US 2026/0158821 A1
(43) Pub. Date: Jun. 11, 2026

(54) REMOVABLE AXLE LOCKING DEVICE

(71) Applicant: Custom Engineered Wheels, Inc., Baldwyn, MS (US)

(72) Inventors: Jeremy L. Howard, Baldwyn, MS (US); Brandon Richter, Stamford, CT (US); Eugene Francis Rudolph, Baldwyn, MS (US)

(21) Appl. No.: 18/969,686

(22) Filed: Dec. 5, 2024

(51) Int. Cl. B60B 27/02; B60B 37/10

(52) U.S. Cl. CPC B60B 27/02; B60B 37/10; B60B 2900/112; B60B 2900/113; B60B 2900/115; B60B 2900/325; B60B 2900/531; B60B 2900/541

(57) ABSTRACT

A removable wheel assembly for use in combination with an axle having an annular groove includes a wheel with a hub assembly. The hub assembly includes a housing with an axle bore configured to receive the axle, and an axle locking device received within the housing adjacent the axle bore. The axle locking device includes a retaining portion configured to secure the axle locking device within the housing, a release portion, wherein at least a portion of the release portion is located outside the housing, and an axle locking portion extending between the retaining portion and the release portion, and configured to operatively interact with the annular groove on the axle when in a first position. The release portion is configured to be displaced away from the axle bore to displace the axle locking portion outwardly from the annular groove when in a second position.

### FIELD OF THE INVENTION

The present technology relates to removable wheel assemblies. More particularly, the present technology relates to an axle locking device for use with a removable wheel assembly that allows the wheel to be easily removed and replaced without the need for extra tools.

### BACKGROUND OF THE INVENTION

Wheel assemblies used on small or lightweight vehicles, such as waste and recycling containers, carts, medical transportation devices, mobility aids, golf carts, toy wagons, tricycles, baby carriages, etc., typically have a metal or plastic wheel with a central aperture through which passes an axle. Typically, wheels for small vehicles are difficult to remove and maintain because the wheels are installed in such a way as to be nearly permanent without the use of special tools to remove the wheel. Some wheels use a one-way cantilevered catch having a protrusion that is chamfered in the direction of installation and sharp on the direction to pull the wheel off. The chamfer catches in a notch near the end of the axle. To remove such a wheel, one would need a screwdriver or another tool to pull the catch outward to remove the wheel. The use of cotter pins may also secure a wheel, but again requires a tool to remove the wheel.

There is an increasing desire for wheels for small vehicles that are easy to assemble by hand without tools. Snap lock wheel assemblies can provide easy to assemble products because such assemblies may have an axle and a wheel that connect together without the use of any tools. However, these assemblies can be a combination of multiple parts increasing the assembly difficulty and time. Additionally, assemblies with multiple parts increase inventory requirements, manufacturing cost and the risk of part failure.

Easily changeable wheels are desirable as they make maintenance simple. Small or lightweight vehicles, such as e.g., garbage cans, are usually tough enough to withstand prolonged periods of use. However, protruding wheels are vulnerable to damage or wear as the moving part of the can that supports the weight of the vehicle and its contents. If a wheel becomes damaged throughout the life of a vehicle, the entire vehicle does not have to be replaced. A replacement wheel or wheels, with simple instructions, could be shipped and installed on the vehicle, possibly even by an end user of such vehicle. Further, easily removable wheels may facilitate easier shipment and/or storage of such vehicles. If wheels can be easily removed, the vehicles could be stacked in a small space, with the wheels being stored in the innermost can. Upon delivery to its final location, the wheels could be installed on the vehicle.

Therefore, it is desirable to provide a removable wheel assembly that allows for easy removal of the wheel by a user without the need for special tools. It is also desirable to provide a removable wheel assembly that is less costly to manufacture and is easier to install. Furthermore, it is desirable to provide a removable wheel assembly that is user friendly and makes it easy to remove and replace the wheel.

### SUMMARY OF THE INVENTION

According to an example embodiment of the present technology, a hub for a removable wheel assembly is provided, including a housing with an axle bore configured to receive an axle, and an axle locking device received within the housing adjacent the axle bore. The axle locking device includes an axle locking portion that extends into the axle bore to interact with the axle when in a first position, and a resilient release portion extending from the axle locking portion, wherein at least a portion of the resilient release portion is located outside the housing, the resilient release portion configured to be displaced away from the axle bore to displace the axle locking portion outwardly from the axle bore when in a second position. The axle is locked in the hub in the first position and is released from the hub in the second position.

In some embodiments, the axle locking device further includes a retaining portion that secures the axle locking device within the housing. In certain of these embodiments, the retaining portion has a longitudinal axis that extends substantially parallel to a longitudinal axis of the axle bore and the release portion extends at an angle relative the longitudinal axis of the retaining portion. The angle may be from about 130 to about 170 degrees.

In certain embodiments, the axle locking device is made from a single strip of material that is bent to create the axle locking portion and the resilient release portion.

In some embodiments, the axle locking portion includes at least one curved surface configured to contact the axle to facilitate displacement of the axle locking portion from the axle bore during insertion of the axle into the axle bore.

According to another exemplary embodiment of the present technology, a removable wheel assembly for use in combination with an axle having an annular groove adjacent an end of the axle includes a wheel with a hub assembly, wherein the hub assembly includes a housing with an axle bore configured to receive the axle, and an axle locking device received within the housing adjacent the axle bore. In some embodiments, the axle locking device includes a retaining portion configured to secure the axle locking device within the housing, a release portion, wherein at least a portion of the release portion is located outside the housing, and an axle locking portion extending between the retaining portion and the release portion, and configured to operatively interact with the annular groove on the axle when in a first position, wherein the release portion is configured to be displaced away from the axle bore to displace the axle locking portion outwardly from the annular groove when in a second position.

In certain embodiments, the axle locking device is integrally formed of a resilient material that is shaped to create the retaining portion, the axle locking portion and the release portion.

A further embodiment of the present invention is an axle locking device, including a retaining portion with a longitudinal axis, a release portion extending at an angle relative the longitudinal axis of the retaining portion, and an axle locking portion extending between the retaining portion and the release portion, and configured to interact with an axle when in a first position. The release portion is configured to be displaced to displace the axle locking portion into a second position where it does not interact with the axle, and the axle locking device is integrally formed of a resilient material that is shaped to create the retaining portion, the axle locking portion and the release portion.

In some embodiments, the axle locking device also includes a ramp positioned on the retaining portion with a downward slope towards an end of the retaining portion opposite the axle locking portion. In additional embodiments, the retaining portion includes a portion having one or more serrated edges.

In certain embodiments, the axle locking device is made with stainless steel.

In some embodiments, the axle locking device is integrally formed of a material having a tensile strength of about 50 to about 100 ksi. In additional embodiments, the axle locking device is integrally formed of a material having a maximum Brinell hardness of about 150 to about 275.

The foregoing and other aspects, features, and advantages of the application will become more apparent from the following description and from the claims.

### BRIEF DESCRIPTION OF THE DRAWINGS

The features of the application can be better understood with reference to the drawings described below, and the claims. The drawings are not necessarily to scale, emphasis instead generally being placed upon illustrating the principles described herein. In the drawings, like numerals are used to indicate like parts throughout the various views.

FIG. 1 is a perspective view of a waste container with a removable wheel assembly mounted thereto.

FIG. 2A is a cross-sectional view of a removable wheel assembly with an axle locking device according to an embodiment of the present invention.

FIG. 2B is a cross-sectional view of the removable wheel assembly of FIG. 2A, showing the wheel assembly mounted on an axle.

FIG. 2C is a cross-sectional view of the removable wheel assembly of FIG. 2A, showing the wheel assembly being inserted onto the axle.

FIG. 2D is a cross-sectional view of the removable wheel assembly of FIG. 2A, showing actuation of the axle locking device to release the wheel assembly from the axle.

FIG. 3 is an enlarged partially cross-sectional view of the axle locking device of FIG. 2.

FIG. 4A is a perspective view of the axle locking device according to an exemplary embodiment of the present invention.

FIG. 4B is a side view of the axle locking device of FIG. 4A.

FIG. 5A is a perspective view of the axle locking device according to another exemplary embodiment of the present invention.

FIG. 5B is a top view of the axle locking device of FIG. 5A.

FIG. 5C is a side view of the axle locking device of FIG. 5A.

### DETAILED DESCRIPTION OF THE INVENTION

The following definitions and methods are provided to better define the present disclosure and to guide those of ordinary skill in the art in the practice of the present disclosure. Unless otherwise noted, terms are to be understood according to conventional usage by those of ordinary skill in the relevant art.

As used in the description, the terms “top,” “bottom,” “above,” “below,” “over,” “under,” “above,” “beneath,” “on top,” “underneath,” “up,” “down,” “upper,” “lower,” “front,” “rear,” “back,” “forward” and “backward” refer to the objects referenced when in the orientation illustrated in the drawings, which orientation is not necessary for achieving the objects of the invention.

The term “about” or “approximately” when immediately preceding a numerical value means a range (e.g., plus or minus 10% of that value). For example, “about 50” can mean 45 to 55, “about 25,000” can mean 22,500 to 27,500, etc., unless the context of the disclosure indicates otherwise, or is inconsistent with such an interpretation. For example, in a list of numerical values such as “about 49, about 50, about 55, . . . ”, “about 50” means a range extending to less than half the interval(s) between the preceding and subsequent values, e.g., more than 49.5 to less than 52.5. Furthermore, the phrases “less than about” a value or “greater than about” a value should be understood in view of the definition of the term “about” provided herein. Similarly, the term “about” when preceding a series of numerical values or a range of values (e.g., “about 10, 20, 30” or “about 10-30”) refers, respectively to all values in the series, or the endpoints of the range.

As used herein, the singular forms “a,” “an,” and “the” include plural referents unless the content clearly dictates otherwise.

The term “comprising” is synonymous with “including,” “having,” “containing,” or “characterized by.” These terms are inclusive and open-ended and do not exclude additional, unrecited elements or method steps.

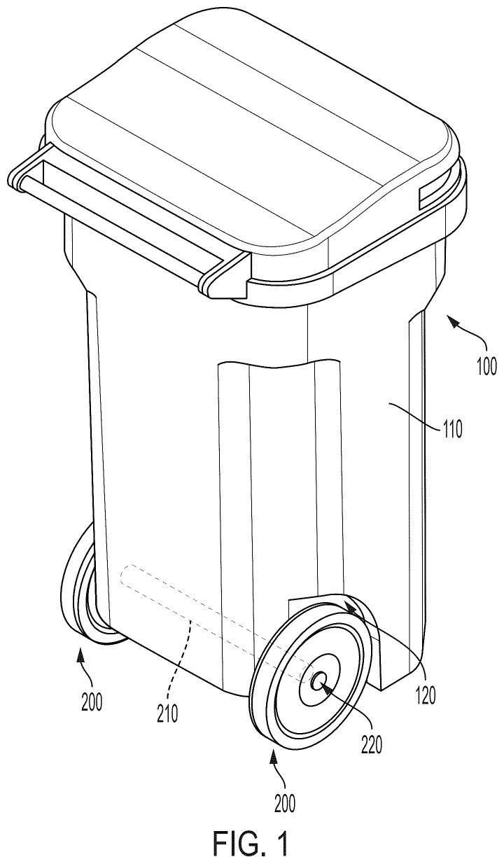

The removable wheel assemblies in accordance with the present technology may be used in connection with various wheeled devices. FIG. 1 illustrates an exemplary embodiment of a waste container 100 that includes a plurality of removable wheel assemblies 200 mounted on an axle 210. A lower end of a cart body 110 may include a recess area 120 configured to receive the removable wheel assemblies 200. As described in detail below, the removable wheel assemblies 200 are secured on the axle 210 by a hub assembly 220. It is understood that the wheel assemblies described herein are suitable for use with other small or lightweight wheeled vehicles, including, but not limited to, waste and recycling containers, carts, medical transportation devices, mobility aids, material handling containers and carts, agricultural products, golf carts, wheeled toys, lawn and garden products, wagons, wheeled food and beverage coolers, barbecues, tricycles, bicycles scooters, baby carriages, and the like.

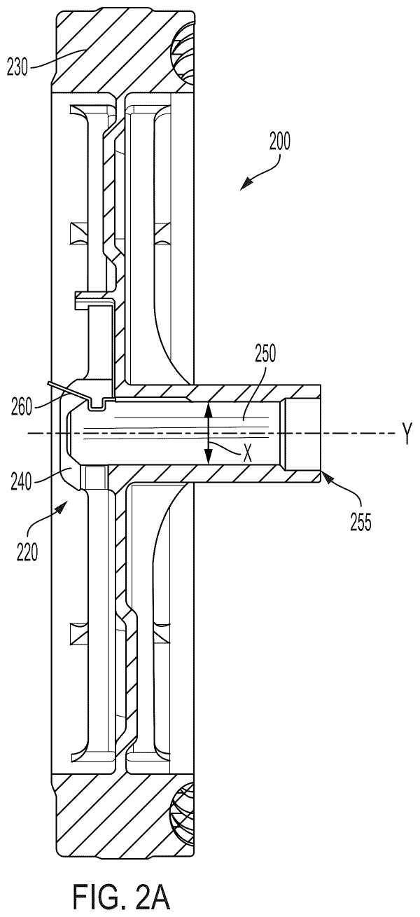

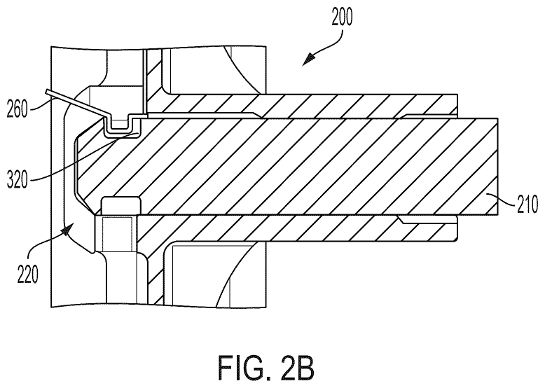

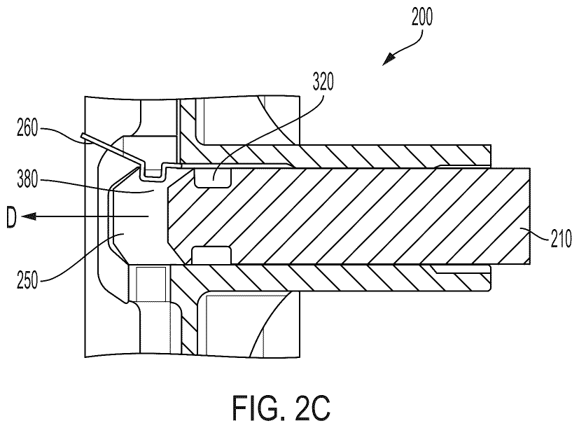

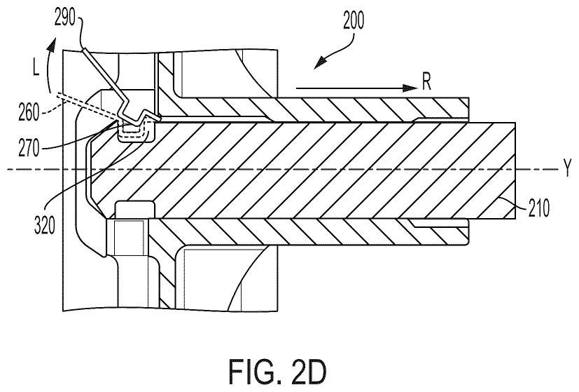

FIG. 2A illustrates a removable wheel assembly with an axle locking device according to an exemplary embodiment of the present invention. The wheel assembly 200 includes a generally cylindrical wheel portion 230 and the hub 220 located centrally in the wheel portion. In some embodiments, the wheel is blow molded. Rolling surfaces of wheels, for example being smooth or including treads, may be integrated into the molding process or may be formed in a multi-step process known as multi-shot molding. It will be appreciated that wheel assemblies 200 described herein may comprise wheels manufactured using other processes (e.g., rotational or compression molding) and/or having other features. For example, the wheel may comprise materials such as wood, metal, rubber, combinations thereof, etc.

The hub 220 has a housing 240 with an axle bore 250 configured to accommodate the axle 210. The bore 250 has an inner diameter X and a longitudinal axis Y. The inner diameter X of the bore is preferably slightly bigger than an outer diameter of the axle 210 such that the axle can be accommodated inside the bore, as shown in FIG. 2B. The bore 250 extends through the hub 220 and is opened at least at one end 255 through which the axle 210 is inserted into the bore 250. The bore 250 may also be opened at the opposite end or may have a hub cap, as shown in FIGS. 2A-2D, that covers the bore end to provide a secure attachment and/or for aesthetic purposes. In some embodiments, the hub 220 is integrally formed with the wheel assembly 200 by blow molding, injection molding or other suitable manufacturing methods.

The hub includes an axle locking device 260. The axle locking device 260 is received within the hub housing 240 adjacent the axle bore 250 such that at least a portion of the axle locking device extends into the axle bore when the axle locking device is in the first position as shown in FIG. 2A. The portion of the axle locking device extends into the axle bore through a locking opening 300 provided in a housing wall forming the axle bore 250. The locking opening 300 is connected with the axle bore 250, allowing a portion of the axle locking device 260 to extend into the bore through the opening 300. The axle locking device 260 is secured within the housing by any suitable method, such as over-molding, gluing, etc. In one preferred embodiment, the axle locking device 260 is secured within the housing 240 during the molding process. Preferably, the axle locking device does not require any other separate elements or parts to be secured within the hub housing.

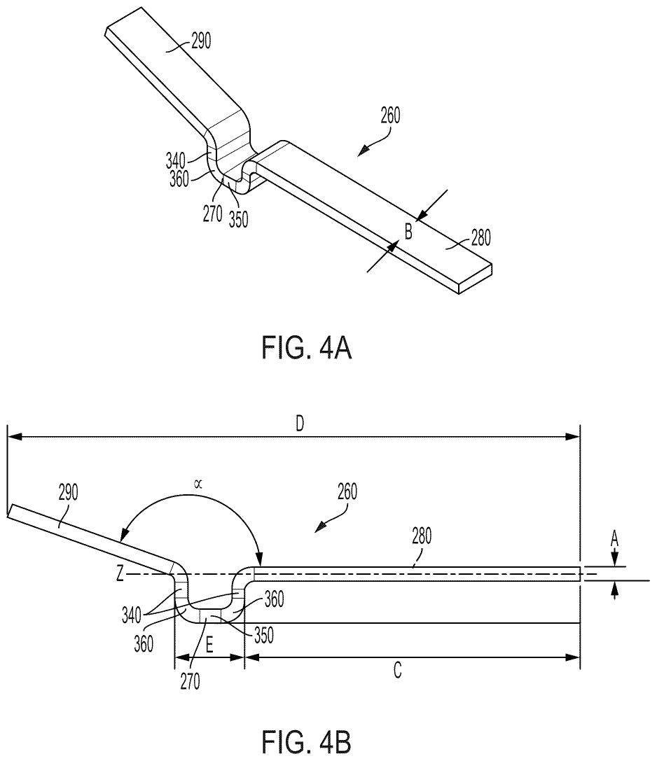

One exemplary embodiment of the axle locking device is illustrated in FIGS. 4A-4B. The axle locking device 260 includes an axle locking portion 270, a release portion 290 and a retaining portion 280. In some preferred embodiments, the axle locking device is made from a single strip of material that is bent to create the axle locking portion and the resilient release portion. Stainless steel or another material that has suitable characteristics, e.g., sufficient strength and resilience, may be used for the axle locking device. In one preferred embodiment, 303 grade stainless steel is used. In other preferred embodiments, 302 grade steel and 304 grade stainless steel may be used. The material used for the axle locking device has a tensile strength of about 25 to about 150 ksi, or about 50 to about 100 ksi, or about 75 ksi to about 85 ksi. The material also has a max Brinell hardness of about 100 to about 300, or about 150 to about 275, or about 175 to about 225. The body of the axle locking device may have various widths and thicknesses depending on a type of the wheel assembly. In some embodiments, the body of the axle locking device has a thickness A of about 0.015 inches to about 0.05 inches, or about 0.03 inches to about 0.04 inches, or about 0.035 inches. The axle locking device body may have a width B of about 0.1 inches to about 0.4 inches, or about 0.2 inches to about 0.3 inches, or about 0.25 inches. It is understood that the thickness and/or width of the axle locking device may be adjusted for applications with larger or smaller removable wheel assemblies.

As shown in FIGS. 4A and 4B, the retaining portion 280 of the axle locking device is planar and extends along a longitudinal axis “Z”. The retaining portion 280 is used to secure the axle locking device 260 within the housing 240 of the hub 220, as discussed above. For example, the retaining portion 280 may extend into the housing wall and have the housing material molded over it to secure the axle locking device. A length “C” of the retaining portion 280 is chosen depending on the hub and/or wheel size and to provide a secure attachment to the hub housing. In some embodiments, the length “C” is about 0.5 to about 2 inches, or about 0.5 to about 1 inches, or about 0.6 inches. When the axle locking device 60 is positioned inside the hub housing, the longitudinal axis “Z” of the retaining portion 280 is preferably substantially parallel to the longitudinal axis “Y” of the axle bore 250, as illustrated in FIG. 2A.

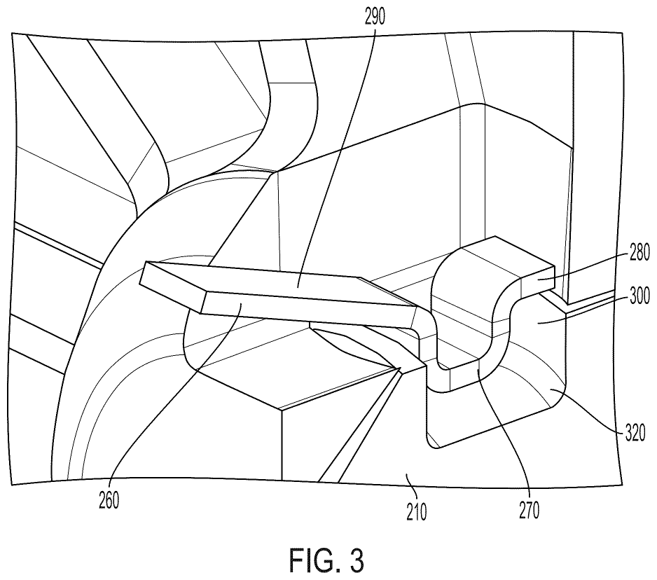

The axle locking portion 270 of the locking device may be formed by bending the body of the locking device four times to create a curved section that extends perpendicular to the longitudinal axis “Z” of the retaining portion 280. The axle locking portion 270 is received within the annular groove 320 of the axle 210, as seen in FIGS. 2B and 3, when the axle locking device 260 is in the first or “locked” position. This prevents the axle 210 from exiting the axle bore 250 and thus secures the wheel assembly 200 on the axle 210. The width “E” of the axle locking portion 270 is such that it fits in the annular groove 320 of the axle 210. The width may be adjusted depending on the type and size of axle used. The depth of the axle locking portion 270—i.e., the distance between the longitudinal axis “Z” and the bottom of the locking portion 270—is such that it sufficiently extends into the axle bore 250 and the annular groove 320 of the axle 210 to securely fix the axle in the bore. In some embodiments, the depth is at least about 50% of the depth of the annular groove 320, or at least about 75% of the depth of the annular groove 320. As shown in FIG. 4B, the axle locking portion 270 is formed by two side walls 340 extending substantially perpendicular to the longitudinal axis “Z” and a bottom wall 350 that is substantially parallel to the axis “Z”. In some preferred embodiments, each of the side walls 340 is connected to the bottom wall 350 through a curved section 360. The curved sections 360 assist positioning of the axle within the axle bore and articulating the axle locking device into a second or “unlocked” position, as described in more detail below. It is understood that in other embodiments, the connection points 360 between the side walls 340 and the bottom wall 350 may have a chamfered shape.

The release portion 290 of the axle locking device 260 extends from the axle locking portion 270 opposite the retaining portion 280. The release portion is positioned in the hub housing 240 such that at least a portion of the release portion 290 is located outside the housing 240. The release portion 290 may extend from the hub housing 240 on either side of the wheel assembly 200. In some preferred embodiments, the release portion 290 extends from the hub housing on the outer side of the wheel—i.e., the side facing away from the axle. This way, the release portion can be easily accessed by the user to release the wheel from the axle, when desired. The release portion 290 is configured to be displaced away from the axle bore 250 to displace the axle locking portion 270 of the axle locking device 240 outwardly from the bore 250 when in the second or “unlocked” position, as shown in FIG. 2D. The release portion 290 is displaced by applying force to it by a user's finger(s). The resilient nature of the material used for the axle locking device 260 allows the release portion 290 and the locking portion 270 of the device 260 to be displaced away from the axle bore 250, while the retaining portion 280 remains fixed in the hub housing 240. When the axle locking device portion 270 is completely displaced out of the annular groove 320 of the axle 210, the axle is no longer locked inside the axle bore 250 and the wheel assembly 200 may be removed from the axle. As seen in FIG. 4B, the release portion 290 of the axle locking device 260 extends at an angle “α” relative the longitudinal axis “Z” of the retaining portion 280. The angle “α” is selected to optimize the amount of force needed to displace the locking device from the axle bore. The angle “α” may be from about 100° to about 180°, or from about 120° to about 170°, or from about 130° to about 160°. In some embodiments, the angle “α” is about 160°.

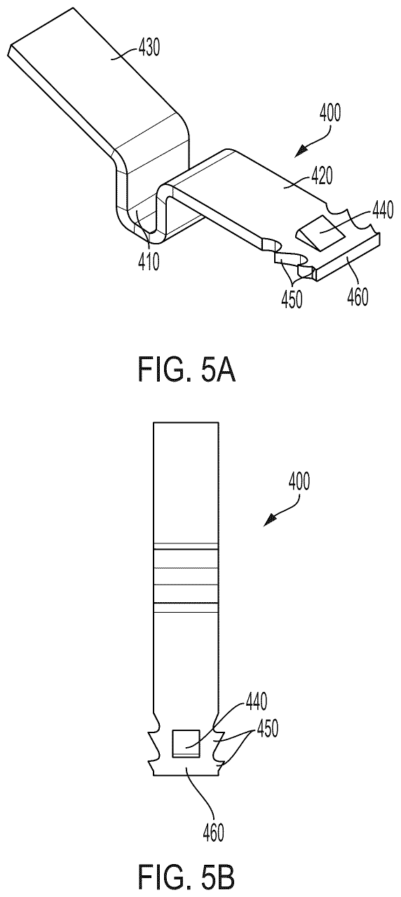

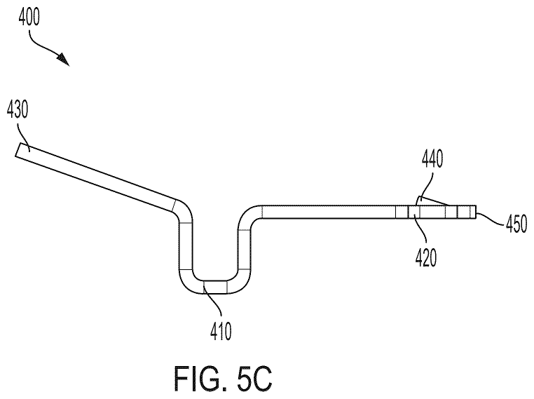

Another exemplary embodiment of the axle locking device 400 in accordance with the present invention is illustrated in FIGS. 5A-5C. Similar to the embodiment shown in FIGS. 4A-4B, the axle locking device 400 includes a retaining portion 420, an axle locking portion 410 and a release portion 430. The shape and dimensions of these portions may be similar to that described above for FIGS. 4A and 4B. In this embodiment, the retaining portion 420 includes a ramp 440 positioned adjacent the end 460 of the retaining portion 420 opposite the locking portion 410. The ramp has a raised edge and a downward slope in the direction of the end 460. The ramp facilitates a secure positioning of the axle locking device 400 in the hub housing 240. The retaining portion 420 may also have serrated edges 450 adjacent the end 460 to further secure the axle locking device 400 inside the hub housing.

When a user of the wheel assembly wishes to install the wheel 200 on an axle shaft 210, he or she will first insert the axle 210 into the axle bore 250 through the open end 255 in the direction “D” shown in FIG. 2C. The axle 210 has a chamfer 380 on its end and an annular groove 320 adjacent the chamfer 380. When the chamfer 380 passes by the axle locking portion 270 of the axle locking device 260, as shown in FIG. 2C, the axle shaft 210 will push the axle locking portion 270 into its second position shown in FIG. 2D. The curved portions 360 facilitate displacement of the axle locking portion 270 and insertion of the chamfer 380 into the bore 250. Once the axle shaft 210 is fully inserted into the axle bore 250, the axle locking portion 270 of the axle locking device will return to its first position, as shown in FIG. 2B, and the axle locking portion 270 will extend into the axle bore 250 and be captured within the annular groove 320 to secure the wheel 200 on the axle 210. The resilient nature of the axle locking device 260 prevents the axle locking portion 270 from leaving the bore 250.

If it is desired to remove the wheel 200 at a later time, the user applies force to the release portion 290 of the axle locking device 260 to displace it away from the axle bore 250. Application of the force displaces the resilient axle locking device 260 outwardly from the axle bore 250 in the direction “L” such that the axle locking portion 270 is withdrawn from the annular groove 320 and the axle bore 250, as shown in FIG. 2D. This places the axle locking device into the second position wherein the axle 210 is no longer locked inside the axle bore 250 and can be moved out of the bore in the direction “R” shown in FIG. 2D. Once the axle is withdrawn from the axle bore, the axle locking device can be released by the user and will return to its first position shown in FIG. 2A.

The removable wheel assembly of the present invention presents many advantages over the prior assemblies. It does not require any tools to remove the wheel from the axle, which makes it much easier for the user to remove and/or replace the wheels as needed. Further, it has a simple design that does not require multiple parts which is easier and more cost efficient to manufacture and assemble.

Although the technology has been described and illustrated with respect to exemplary embodiments thereof, it should be understood by those skilled in the art that the foregoing and various other changes, omissions, and additions may be made therein and thereto, without parting from the spirit and scope of the present technology.

What is claimed is:

1. A hub for a removable wheel assembly, comprising:
a housing with an axle bore configured to receive an axle,
an axle locking device received within the housing adjacent the axle bore, wherein the axle locking device comprises:
an axle locking portion that extends into the axle bore to interact with the axle when in a first position, and
a resilient release portion extending from the axle locking portion, wherein at least a portion of the resilient release portion is located outside the housing, the resilient release portion configured to be displaced away from the axle bore to displace the axle locking portion outwardly from the axle bore when in a second position,
wherein the axle is locked in the hub in the first position, and
wherein the axle is released from the hub in the second position.

2. The hub according to claim 1, wherein the axle locking device further comprises a retaining portion that secures the axle locking device within the housing.

3. The hub according to claim 2, wherein the retaining portion has a longitudinal axis that extends substantially parallel to a longitudinal axis of the axle bore.

4. The hub according to claim 3, wherein the release portion extends at an angle relative the longitudinal axis of the retaining portion.

5. The hub according to claim 4, wherein the angle is from about 130 to about 170 degrees.

6. The hub according to claim 1, wherein the axle locking device is made from a single strip of material that is bent to create the axle locking portion and the resilient release portion.

7. The hub according to claim 1, wherein the axle locking portion comprises at least one curved surface configured to contact the axle to facilitate displacement of the axle locking portion from the axle bore during insertion of the axle into the axle bore.

8. A removable wheel assembly for use in combination with an axle having an annular groove adjacent an end of the axle, comprising a wheel with a hub assembly, wherein the hub assembly comprises:
a housing with an axle bore configured to receive the axle, and
an axle locking device received within the housing adjacent the axle bore, wherein the axle locking device comprises:
a retaining portion configured to secure the axle locking device within the housing,
a release portion, wherein at least a portion of the release portion is located outside the housing, and
an axle locking portion extending between the retaining portion and the release portion, and configured to operatively interact with the annular groove on the axle when in a first position,
wherein the release portion is configured to be displaced away from the axle bore to displace the axle locking portion outwardly from the annular groove when in a second position.

9. The removable wheel assembly according to claim 8, wherein the axle locking device is integrally formed of a resilient material that is shaped to create the retaining portion, the axle locking portion and the release portion.

10. An axle locking device, comprising:
a retaining portion with a longitudinal axis,
a release portion extending at an angle relative the longitudinal axis of the retaining portion, and
an axle locking portion extending between the retaining portion and the release portion, and configured to interact with an axle when in a first position, and
wherein the release portion is configured to be displaced to displace the axle locking portion into a second position where it does not interact with the axle, and
wherein the axle locking device is integrally formed of a resilient material that is shaped to create the retaining portion, the axle locking portion and the release portion.

11. The axle locking device according to claim 10, further comprising a ramp positioned on the retaining portion with a downward slope towards an end of the retaining portion opposite the axle locking portion.

12. The axle locking device according to claim 10, wherein the retaining portion comprises a portion having one or more serrated edges.

13. The axle locking device according to claim 10, wherein the axle locking device is made with stainless steel.

14. The axle locking device according to claim 10, wherein the axle locking device is integrally formed of a material having a tensile strength of about 50 to about 100 ksi.

15. The axle locking device according to claim 10, wherein the axle locking device is integrally formed of a material having a maximum Brinell hardness of about 150 to about 275.
